(19) United States
(12) Patent Application Publication
(10) Pub. No.: US 2002/0152200 A1
(43) Pub. Date: Oct. 17, 2002

(54) System and method for retrieving information pertaining to product

(76) Inventors: Philip S. Krichilsky, Charlotte, NC (US); Ramesh Narayanswammy, Huntersville, NC (US); Timothy Wells, Huntersville, NC (US)

Correspondence Address: Hunton & Williams, 1900 K Street, N.W., Washington, DC, 20006-1109, US

(21) Appl. No.: 09/773,538

(22) Filed: Feb. 2, 2001

Related U.S. Application Data
(60) Provisional application No. 60/208,057, filed on May 31, 2000.

(51) Int. Cl. G06F 7/00

(52) U.S. Cl. 707/3

(57) ABSTRACT

A technique is provided for retrieving information pertaining to a product, including: (i) receiving a search query from a user pertaining to a desired product; (ii) investigating a database to determine whether any products include features that satisfy the query, and for generating search results; (iii) informing the user that the desired product is not available, e.g., if the database indicates that the product is not available; (iv) recommending an alternative product as a proposed substitute for the desired product; and (v) receiving a request from the user to order the alternative product and/or to place a request for the desired product on a waiting list. In one exemplary application, the products pertain to sealant-related goods.

### CROSS REFERENCE TO RELATED APPLICATIONS

This application claims the benefit of U.S. Provisional Application No. 60/208,057, filed on May 31, 2000, which is incorporated herein by reference in its entirety.

### BACKGROUND OF THE INVENTION

The present invention generally relates to a system and method for retrieving information pertaining to a product. In a more specific embodiment, the present invention relates to a system and method for retrieving information pertaining to a sealant-related or adhesive-related product.

The growing acceptance of electronic commerce in the marketplace has resulted in the introduction of various “electronic shopping” systems. For instance, users may purchase a variety of products via the Internet using their personal computers. A number of Internet websites cater to consumers interested in purchasing a broad range of “personal-use” items, such as books, musical recordings, clothing, food products, etc. Other Internet websites provide services that allow consumers to purchase items within a specific technical or business-related field. For example, various websites offer assistance to users in purchasing sealant-related or adhesive-related products. Such websites include: (a) <<http://www.glueguru.com/>>; (b) <<http://www.adhesiveworks.com/>>; (c) <<http://www.adhesiveworld.com/>>; (d) <<http://www.hotmeltcity.com/>>; (e) <<http://www.hotmelts.com/>>; (f) http://www.glueforelectronics.com/>>; (g) <<http://www.on-hand.com/>>; (h) <<http://adhesivesmart.com/>>; (i) <<http://www.adhesivesandsealants.com/>>; (j) <<http://www.gepolymerland.com/>>; and (k) http://www.electronicencapsulants.com/>>.

Some shopping-related websites, such as the familiar amazon.com site, operate by prompting a user to specify a search term that characterizes a desired product. The website responds by providing the user with a list of products that match the search term. The user may then order one or more products from the list. Ordered products are placed in an electronic shopping cart, allowing the user to purchase the products at later point in time. The list of matching products also provides an indication of the relative availability of the matching products (such as whether the products are readily available, available by special order, or out-of-stock). This feature allows the users to assess whether the products can be obtained, and if so, how quickly.

Other websites function merely as technical catalogues. In other words, these websites provide a list of matching products by one or more manufacturers, but rely on the user to independently contact the manufacturer and order the selected products. Still other websites facilitate the task of contacting the manufacturers by including contact information and/or interface functionality for use in communicating with the separately maintained order systems provided by the manufacturers.

The approach used by another shopping model is to restrict the searchable database to available products. For instance, a manufacturer may sponsor a site that features only its own available products. Alternatively, a collection of manufacturers may sponsor a site as partners to collectively market their available products. Insofar as these manufacturers ensure the availability of items offered in their database, such a service will not attempt to sell a consumer an unavailable item.

Other shopping models attempt to improve customer satisfaction by enhancing the sophistication of the tools by which the models assess the users' needs. For instance, a “configurator” refers to a type of device which solicits information regarding a customer's needs, and generates a product recommendation based on the assessed needs. Some configurators employ a model-based approach to generate the recommendation, wherein each part in a catalogue is assigned a set of attributes and constraints.

The above-identified approaches to electronic shopping have various shortcomings. For instance, the amazon.com service essentially abandons a user when an ordered product is indicated as unavailable. In response, a user may attempt to use a different electronic shopping provider to obtain the desired product. Alternatively, the user may attempt to reformulate his or her search strategy in hopes of retrieving appropriate available products. Frequent episodes of this nature may lead the consumer to believe that the service is not user-friendly. This may cause the consumer to become frustrated. Electronic catalogues may suffer from similar shortcomings. Namely, customers may be reluctant to use a service where they are prevented from making an immediate purchase.

The use of a database populated solely with available items eliminates the complications associated with the attempted sale of an unavailable item. However, such a database may contain a relatively small number of products compared to the total “universe” of products that would serve the user's needs. As a general rule, the utility of a search is partly dependent on the “richness” of the data pool from which it draws matching candidates. Hence, a customer may become dissatisfied with a search service that relies on a relatively small database of products.

The use of configurators does not directly address the above-identified problems. As noted above, such a technique may allow a search engine to more precisely match a consumer's needs with a defined database of products, and may use sophisticated algorithms to perform this function. However, this technique does not directly address the difficulty encountered when a user selects an unavailable item for purchase. Further, to the extent that the configurator relies on a limited database, its recommendations may be similarly limited for the reasons set forth above.

More generally, an effective search engine that is designed for commercial advantage should preferably serves two objectives. First, it should perform in an effective manner for the end-user of the service (e.g., by providing a user-friendly interface and by generating useful results). Second, it should perform in an effective manner for the provider of the system (e.g., by providing mechanisms that enable the provider to use the service to achieve a defined marketing advantage). There is no indication that the above-described techniques fully satisfy both of these objectives.

To compound the above design challenges, some technical fields, such as the sealant/adhesive-related technical field, involve the sale of products having a myriad of searchable properties. Hence, a user may have difficulty formulating an appropriate search query that captures his or her product needs. Further, even if the user does provide an effective search query, the user may have difficulty comparing products provided by different manufacturers.

Accordingly, there is a need in the art to provide a more effective system and method for ordering products, and in a more particular embodiment, ordering sealant-related products.

### BRIEF SUMMARY OF THE INVENTION

The disclosed technique solves the above-identified difficulties in known systems, as well as other unspecified deficiencies in the known systems.

According to one exemplary aspect of the invention, a technique is provided for retrieving information pertaining to a product, including: (i) receiving a search query from a user pertaining to a desired product; (ii) investigating a database to determine whether any products include features which satisfy the query, and for generating search results; (iii) informing the user that the desired product is not available, if the database indicates that the product is not available; (iv) recommending an alternative product as a proposed substitute for the desired product; and (v) receiving a request from the user to order the alternative product and/or to place a request for the desired product on a waiting list. In one exemplary embodiment, the products pertain to sealant-related goods.

According to another aspect of the invention, the prompting step includes querying the user to input an industry designation related to a topic of inquiry.

The above technique provides various benefits. The recommendation of an alternative product provides a convenient means for steering a user toward an available product in the event that a selected product is not available. This has the dual benefit of facilitating the user's search and also creating a sales opportunity for the service provider.

Further, the use of the industry designation enables the technique to more efficiently satisfy the unique product needs of users, e.g., by providing queries to the user that are specifically targeted to those needs (based on the user's affiliation with an identified industry).

Still further features and advantages of the present invention are identified in the ensuing description, with reference to the drawings identified below.

### BRIEF DESCRIPTION OF THE DRAWINGS

FIG. 1 shows a high-level conceptual view of a search technique according to the present invention;

FIG. 2 shows an exemplary system for implementing the search technique shown in FIG. 1;

FIG. 3 shows an exemplary order processing system for use in the system of FIG. 2;

FIG. 4 shows an exemplary workstation for use in the system of FIG. 2;

FIGS. 5-7 show exemplary processing performed by the system of FIG. 2; and

FIGS. 9-16 show exemplary screen presentations for display at an input/output interface unit of the workstation of FIG. 4.

### DETAILED DESCRIPTION OF THE INVENTION

The invention relates to the retrieval of information pertaining to products. In a general embodiment, the term “products” includes any type of goods that may be purchased for any reason. For instance, the term “products” may include goods purchased for personal consumer consumption, such as books, musical recordings, clothing, food products, etc. The term “products” may also include goods purchased primarily for business-related uses, such as raw materials, building materials, parts for machinery, etc.

In a more particular embodiment, the term “products” refers to sealant-related products and/or adhesive-related products (collectively referred to as simply “sealants” for brevity and convenience). One type of sealant is used to join two types of materials together. Another type of sealant is primarily used to fill in openings (such as cracks or joints) in a single type of material. Another type of sealant is used primarily to coat a material. Still other applications of sealants may exist. Thus, the term “sealant” encompasses any substance which adheres to a material to perform any type of sealing function for any purpose.

The individuals requesting information regarding sealants typically include users that require such products for a business-related purpose. The individuals may be categorized based on the industry-related fields of their respective endeavors. Exemplary industry-related fields include: electronics and telecommunications applications; glazing applications; maintenance and repair applications; marine applications; non-woven/hygiene applications; other construction applications; other industrial assembly applications; other packaging applications; transportation-related applications; window manufacturing applications; and woodworking applications. Other industry-related categories may be provided to cater to specific groups. Of course, the individuals requesting information regarding the sealants may also include users that are requesting such products for “personal” (e.g., home maintenance) purposes.

To facilitate explanation, the ensuing discussion is framed in the specific context of the retrieval of information regarding sealants (as defined above). However, it should be kept in mind that the principles disclosed herein are equally applicable to any type of product.

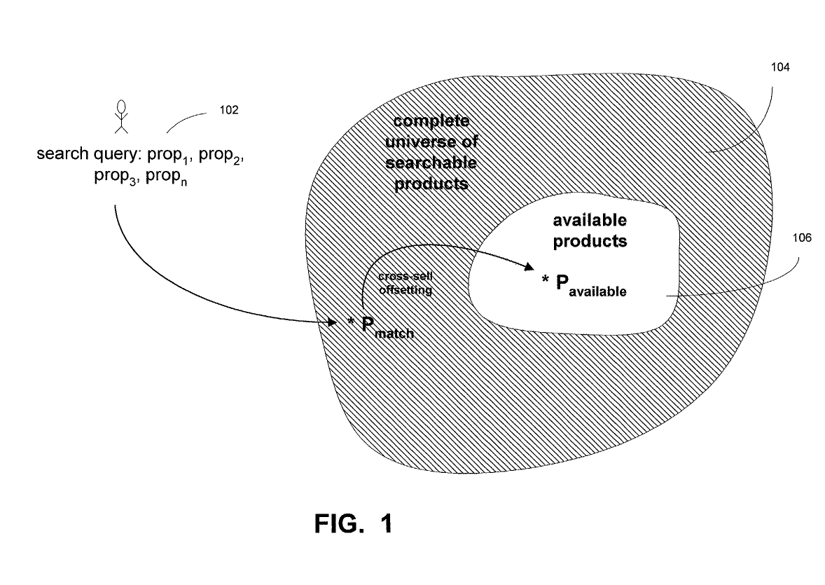

Now turning to the figures, FIG. 1 shows an overview of the search technique employed by the present invention. A database is included which contains a group of “searchable products” 104, and another group of “saleable” or “available products” 106. As the names suggest, an order processing system (not shown) permits retrieval of information regarding entries that lie within the group of searchable products 104. However, the order processing system may permit a user to place orders through its interface for only available products 106. As shown in FIG. 1, the group of available products 106 forms a subset entirely encompassed by the larger group of searchable products 104. As such, in this case, the available products are also searchable products. In other embodiments, one or more available products may not “lie” within the group of searchable products 104. In another embodiment, the entire set of available products 106 may lie outside the domain of the searchable products 104.

In operation, a user (as defined above) formulates a search query 102. The query may specify search criteria that define the properties of the desired product(s) (i.e., prop₁, prop₂, prop₃, . . . propₙ). In response to the query, the order processing system investigates the group of searchable product 104, and then returns information regarding the products in that set that match the query. In the exemplary case of FIG. 1, the order processing system identifies a product denoted as “*P_{match}” as matching the search query. This product lies outside the set of available products 106, and is therefore unavailable for direct purchase via the order processing system. In response to this determination, the ordering processing system will forward a message to the user to inform the user of the status of the identified product “*P_{match}.”

However, instead of simply “abandoning” a user, the order processing system determines whether any products exist within the set of available products 106 that are related to “*P_{match}.” In the exemplary case of FIG. 1, the order processing system identifies the product “*P_{available}” as being related to the product “*P_{match}.” Accordingly, the order processing system sends a message to the user inviting the user to purchase the product “*P_{available}.”

The order processing system may use different paradigms to identify products within the available group 106 based on the user's selection of unavailable products (i.e., products outside the available group 106). In one embodiment, the order processing system may relax one or more parameters in the search query to expand the list of matching products, thereby increasing the chances that one or more products in the list will be available. In another embodiment, the order processing system may include pre-stored information in its database which links unavailable products to available products. In one case, this linking information identifies related families of products. Further, the order processing system may recommend available products based on various non-technical factors. For instance, the order processing system may be configured to identify or emphasize products produced by “preferred” manufacturers.

The search technique used in the present invention thus provides a unique combination of advantageous features. For instance, the use of a relatively large database of searchable products provides a rich source of information. Further, insofar as the database is populated with information from multiple commercial sources, the search may be regarded as “neutral” or “non-biased.” In addition, the practice of cross-referencing a matching product (selected as a result of the neutral search) with a smaller data set of available products (e.g., in the event that the matching product is unavailable) provides a powerful mechanism for marketing the available products.

The coupling of a neutral search with a targeted cross-reference to a group of available products is a notable improvement in the electronic shopping arts. Such a technique is advantageous to the end-user in that it places a large product database at his or her disposal, and additionally consummates a user's search session with a purchase (if an available item can be found). Further, such a technique is advantageous to the service provider because it empowers the provider with a tool to target-market products in the available database 106.

The order processing system may also allow a user to place a selected unavailable product on a wait list (also referred to as a “watch list”). In this case, if the selected product becomes available in the future, the order processing system notifies the user (e.g., via e-mail, facsimile, etc.). Alternatively, the order processing system may be configured to automatically order the selected product when it becomes available.

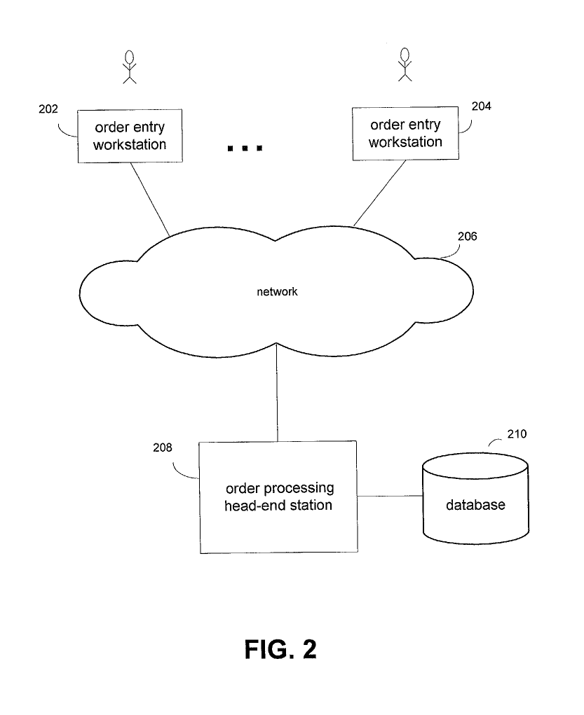

The remainder of the figures present further details regarding the above-described shopping-related features. To begin with, FIG. 2 shows an overview of an electronic system that can be used to implement the present invention. The system includes an order processing head-end station (or system) 208 coupled to one or more order entry workstations (e.g., workstations 202 and 204) via a network 206. The order processing system 208 is also coupled to a database 210, which stores information pertaining to searchable and available products.

The network 206 may comprise any type of local-area or wide-area network. For instance, the network 206 may be formed by an Internet connection, an intranet connection, a PAN (Personal Area Network), a LAN (Local Area Network), a WAN (Wide Area Network), a MAN (Metropolitan Area Network), a storage area network (SAN), etc. The network may further include wireless connection(s), such as a WAP (Wireless Application Protocol) link, a GPRS (General Packet Radio Service) link, a GSM (Global System for Mobile Communications) link, any type of spread spectrum or TDMA (Time Division Multiple Access) link, etc. The network 206 may operate using any type of network-enabled code, such as HyperText Markup Language (HTML), Dynamic HTML, Extensible Markup Language (XML), Extensible Stylesheet Language (XSL), Document Style Semantics and Specification Language (DSSSL), Cascading Style Sheets (CSS), etc.

In operation, shoppers may use respective workstations (e.g., workstations 202 and 204) to access the order processing system 208 via the network 206. In one embodiment, the workstations may gain access by inputting the address of an Internet website maintained by the order processing system 208. This allows the users to navigate through various screens provided by the website (to be discussed in greater detail below). In response to the users' queries, the order processing system 208 accesses and retrieves product-related information from the database 210.

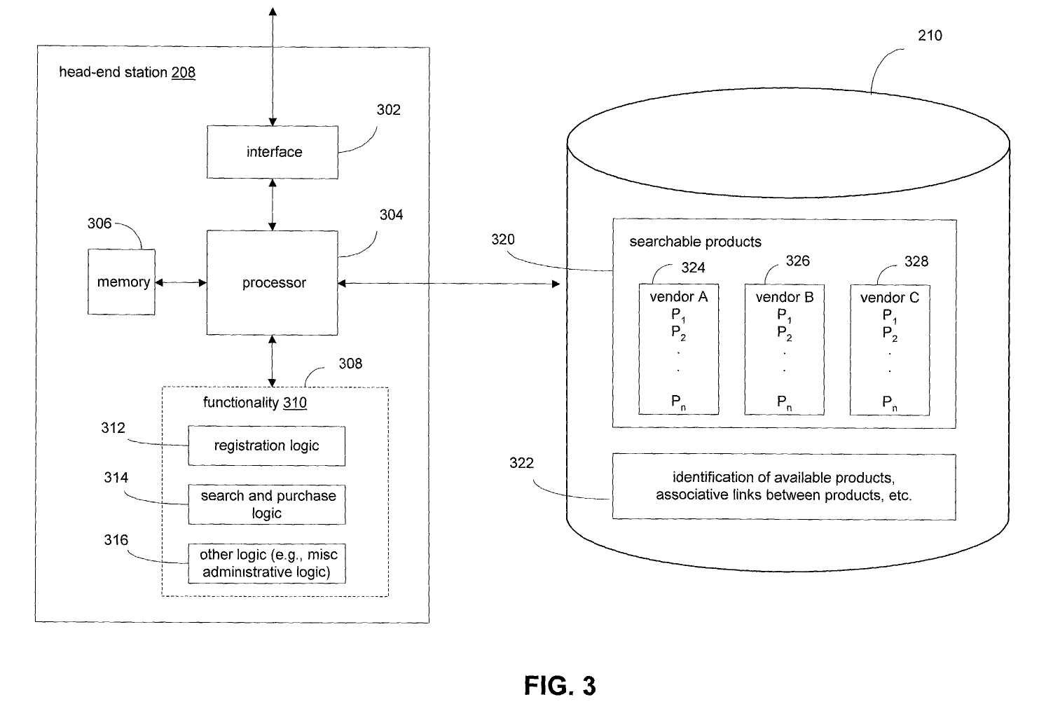

With reference to FIG. 3, the order processing system 208 includes conventional head-end processing components, including a processor 304 (such as a microprocessor), memory 306, cache (not shown), and interface 302. The processor 304 serves as the central engine for executing machine instructions. The memory 306 (such as a Random Access Memory, or RAM) serves the conventional role of storing program code and other information for use by the processor 304. The interface 302 serves the conventional role of interacting with external equipment, such as the workstations 202 and 204.

The order processing system 208 may also comprise processing functionality 308. Such processing functionality 308 may represent machine-readable instructions for execution by the processor 304 for carrying out various functions. Such machine-readable instructions may be stored in any type of memory, such as CD ROM, magnetic media, etc. The processing functionality 308 includes registration logic 312 for handling the administration tasks involved in the registration of users. The processing functionality 308 may also include search and purchase logic 314 for processing the users' search queries and order requests (and related tasks). The processing functionality 308 may also include other processing logic 316 for executing other routines provided by the order processing system 208.

The order processing system 208 may be implemented using various head-end architectures. For instance, the order processing system 208 may be implemented as a server (e.g., in the context of a client-server architecture). Such a server may be implemented using any one of various operating system platforms, such as Microsoft Windows™ NT™, Windows™ 2000, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform. In an alternative embodiment, the order processing system 208 may be implemented using an architecture other than a client-server type architecture. For instance, the order processing system 208 may be implemented using a mainframe-type architecture.

In one embodiment, the processing system 208 comprises a single computer. Alternatively, the order processing system 208 may comprise multiple computers connected together in a distributed fashion, each of which may implement/administer a separate aspect of the functions performed by the order processing system 208.

The database 210 includes first information 320 that identifies “searchable products,” corresponding to the group of searchable products 104 shown in FIG. 1. More specifically, the first information may pertain to products produced by multiple vendors (e.g., manufacturers), such as products produced by vendor A, products produced by vendor B, products produced by vendor C, etc. The database 210 may allocate a single file for storing the information pertaining to the multiple vendors, or may provide separate files for respective vendors. The database 210 may also include second information 322 that identifies “available products,” corresponding to the group of available products 106 shown in FIG. 1. This second information may comprise a field code within the product records that identifies whether the products are available. Other methods of distinguishing available products from unavailable products may be used.

Generally, the database 210 may comprise a single repository of information, or multiple repositories of information coupled to each other in a distributed fashion. For instance, in one alternative embodiment, the order processing system 208 provides links to separate databases maintained by different providers. Whatever organization is used, a variety of different database tools can be used to implement the database, including the Oracle™ relational database sold commercially by Oracle Corp. Other database platforms, such as Informix™, DB2 (Database 2), Sybase, etc., may also be used.

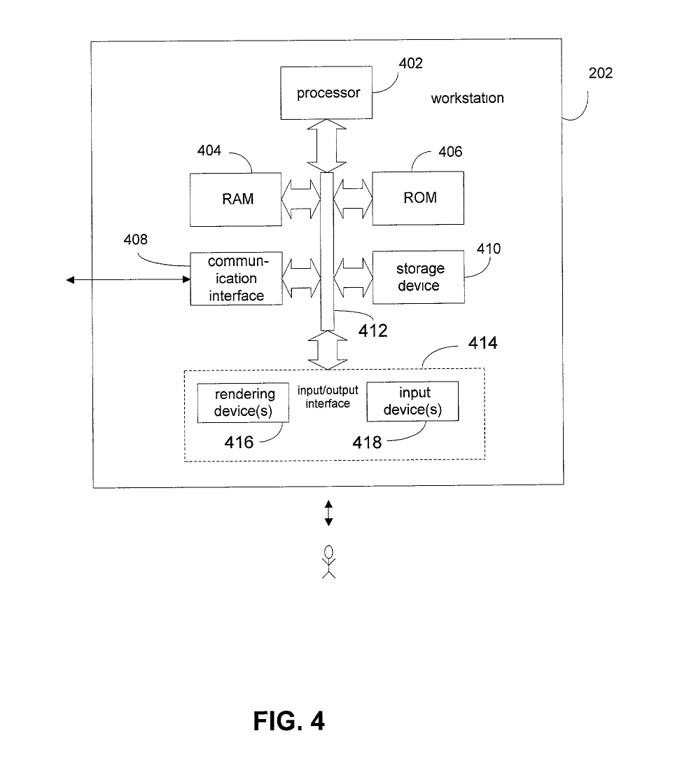

FIG. 4 shows an exemplary workstation (e.g., workstation 202) for interacting with the order processing system 208 of FIG. 2. The workstation 202 represents any type of general or special purpose computer comprising conventional hardware. Namely, the workstation includes a processor 402 connected, via bus 412, to a Random Access Memory (RAM) 404, Read Only Memory (ROM) 406, and storage device 410 (such as a hard drive, CDROM, optical disc, etc.). The workstation 202 further includes an input/output interface unit 414, which, in turn, includes one or more devices 418 for inputting information (such as a keyboard, mouse-type input device, touch screen or panel, etc.), and one or more devices 416 for rendering information (including a display, printer, etc.). In one exemplary embodiment, the input/output interface unit 414 presents the screens identified in FIGS. 8-16. The workstation 102 also includes a communication interface device 408 (such as a modem, etc.) for interacting with external equipment (such as the order processing system 208) via the network 206. The computer may operate using any one of a variety of operating systems, such as the Microsoft Windows™ 98 program.

Other types of input devices can be used to interact with the order processing system 208, such as any type of handheld or wearable device (e.g., a Personal Digital Assistant, a cellular phone, etc.), or other type of device.

In one embodiment, the functionality associated with searching and retrieving product information is confined to the order processing system 108. In another embodiment, the functionality is shared between the order processing system 208 and the workstations (e.g., 202, 204). In the latter case, the order processing system 208 may download software to the workstations to enable the workstations to interact with the order processing system 208.

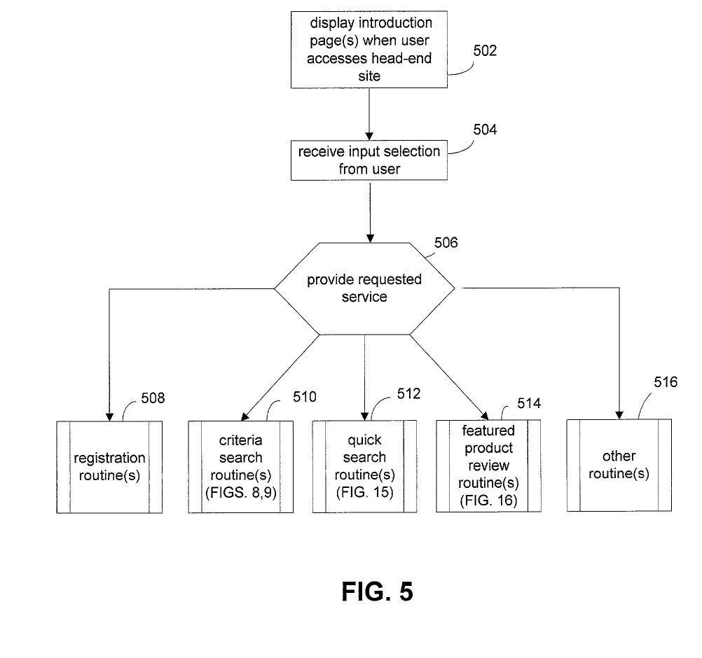

The process flow used in administering the product ordering service is shown in FIG. 5. The process begins when the user accesses the services provided by the order processing system 208, e.g., using workstations 202 or 204. In step 502, the order processing system 208 responds by displaying an introductory (or “home”) page (or pages). The introductory page may contain menu information that identifies various functions that the shopping service may perform. In conventional fashion, the introductory page may include hypertext links “underlying” graphical depictions of the functions. By activating a link (e.g., using a mouse device to point to and “click on” the link), the user may activate its associated function. In the context of FIG. 5, the process includes the step of receiving an input selection from the user (in step 504), which prompts the system to provide the requested service (in step 506).

FIG. 5 identifies a subset of possible functions accessible from the introductory page. For instance, the introductory page allows a user to access a registration routine 508 for performing administrative tasks associated with the registration of new users, and well as other administrative tasks. The registration of users includes collecting various information about the user, such as name, e-mail address, physical address, preferred language, etc. The registration routine also includes collecting information regarding the user's business, such as company name, industry-related category (such as one of the categories defined above), the user's primary role within his or her company, etc. The registration routine also may include collecting information regarding the user's buying channel, information regarding the type of materials that the user is typically interested in purchasing (such as silicones, urethanes, acrylics, butyls, sulfides, epoxies, PVC, tapes, asphalts, etc.), etc. Further, the registration routine may allow the user to select a user identification code and password. Additional registration functions may be provided to suit unique aspects of a provider's administrative infrastructure.

The introductory page also allows a user to access a criteria-based query routine 510. This routine allows a user to input a query including one or more search parameters, to be discussed in greater detail below. Another function provided by the introductory page is a quick search routine 512. This routine allows a user to input a search query using a reduced number of input steps compared to the criteria-based search routine 510. This function is also discussed in greater detail below.

The introductory page may also provide a “featured product” routine 514 that allows a user to access information regarding featured products. In this routine, the order processing system 208 presents information regarding special purchase opportunities. For instance, this routine may present a list of sale items. In one embodiment, a manufacturer may pay the order processing provider for the privilege of having one or more of its products appear in the featured products listing. Alternatively, this routine may present products that the service independently deems particularly suited for the user. An assessment of suitability may be based on the user's industrial affiliation, and/or based on previous searches and/or previous orders placed by the user. That is, the order processing system may detect a pattern in the user's buying habit, and then compile a list of recommended products based on this pattern. This function is also discussed in greater detail below.

The introductory page may also enable a user to select other functions 516. For instance, the introductory page may allow a user to access various research-related information and/or services, such as: a reference library containing information regarding the products; a “facts” page which identifies commonly asked questions regarding the service (and associated answers); a “links” listing which identifies other services that may be accessed via the network 206; a Material Safety Data Sheet (MSDS) page which provides MSDS information regarding products, etc. Further, the introductory page may allow a user to access various purchase-related information and/or services, such as: a shipment tracker function which allows users to track the progress of product shipments; a “payables” function which allows a user to attend to various payment-related tasks associated with the order processing system; a reorder form page which allows a user to specify reorder information; a purchase history page which allows a user to examine information regarding their purchase history, etc. Finally, the introductory page may provide news and related information pertaining to sealants (or pertaining to the search service itself). The order processing system 208 may tailor the news to a user's associated industry. Those skilled in the art will appreciate that additional functionality can be accessed from the introductory page.

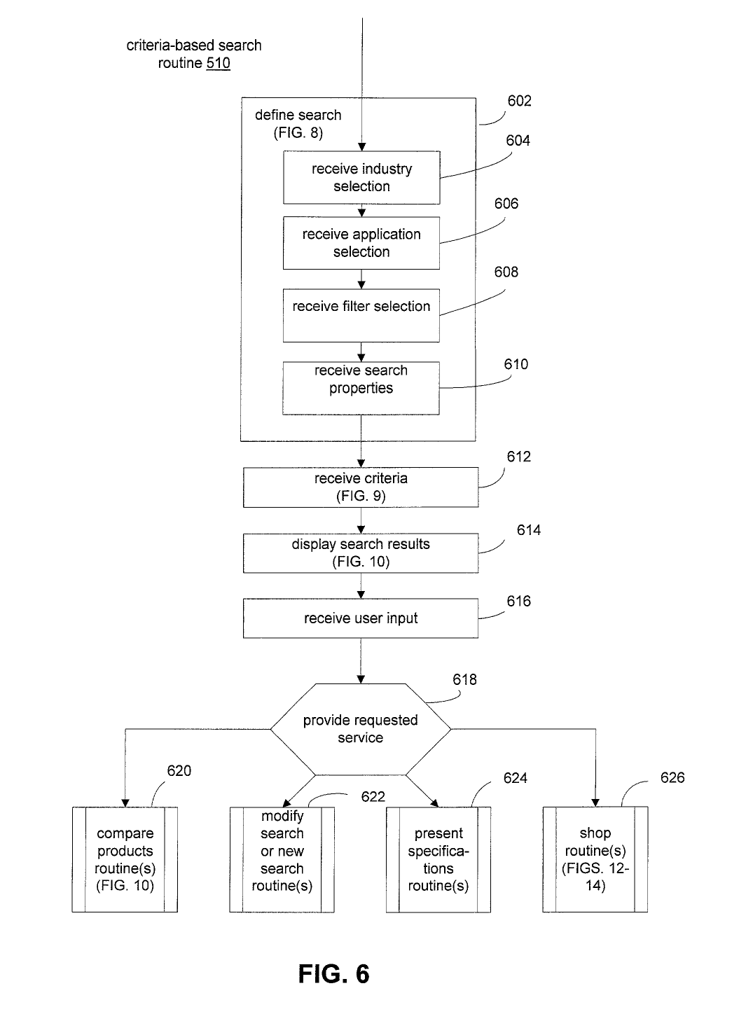

FIG. 6 presents additional information regarding the criteria-based search routine 510. In step 602, the user creates a search query by inputting various information that characterizes a search strategy. Step 602 specifically comprises a step of receiving an industry selection (in substep 604), receiving an application selection (in substep 606), receiving a filter selection (in substep 608), and then receiving a search-property selection (in substep 610).

FIG. 8 shows an exemplary screen 802 for collecting the above-identified information. This screen 802 includes conventional computer pull-down menus 806 (such as File, Edit, View, Insert, Format), as well as a tool bar 804 that may allow access to other functions that are specific to the product ordering system. Input box 808 includes a pull-down menu identifying industry-related selections. This input field is used to specify an industry associated with a user's search query (if appropriate). Exemplary industry-related categories include those identified above. To repeat, these categories include: electronics/telecommunications; glazing; maintenance and repair; marine; nonwoven hygiene; other construction; other industry assembly; packaging; transportation; window manufacturing; and woodworking. Those skilled in the art will appreciate that the order processing system 208 may include additional categories that may be appropriate in specific technical fields. In the example shown in FIG. 8, the user has selected the “maintenance & repair” category (e.g., by clicking on the appropriate entry in the pull-down menu).

Input box 810 includes a pull-down menu of application-related selections. This input field specifies the application associated with a user's search query (if appropriate). Exemplary application-related categories include: an all-inclusive category (e.g., specifying all applications); an adhesive/structural-related application; a bonding-related application; a filler-related application; a maintenance and repair related application; a splicing-related application; and a thread repair application. Those skilled in the art will appreciate that the order processing system 208 may include additional categories that may be appropriate to different technical fields. In the example shown in FIG. 8, the user has selected the “maintenance & repair” category (e.g., by clicking on the appropriate entry in the pull-down menu).

Input box 812 includes a pull-down menu of filter-related selections. This input field specifies various filters that may be applied to the search (which, in turn, governs the selectivity of the algorithm used to match a user's query with the database entries). Exemplary filter categories include: “solving a particular problem” (e.g., where a user aims to solve a particular technical problem); “finding a particular manufacturer” (e.g., where a user aims to restrict the search to specific manufacturers); “locating a specific product chemistry” (e.g., where a user aims to restrict the search to a specific chemical constitution); and “satisfying a particular technical criteria” (where a user intends to find a suitable sealant to satisfy a particular criteria). Those skilled in the art will appreciate that the order processing system 208 may include additional categories that may be appropriate to particular technical fields. In the example shown in FIG. 8, the user has selected the “solving a technical problem category” (e.g., by clicking on the appropriate entry in the pull-down menu).

Field 814 shown in FIG. 8 prompts the user to specify the search properties which are considered important in light of the user's searching objective. The following table identifies exemplary properties that may be displayed in field 814.

TABLE 1

| Property | Description |
|---|---|
| Adhesion | This property refers to the strength with |
| | which two bonded surfaces are held |
| | together with an adhesive, also known |
| | as the bond strength. Quantitative tests |
| | are available for measuring the adhesive |
| | strength under various environmental |
| | conditions. This property is measured |
| | in units such as psi. |
| Adhesive Type | This property identifies a cure system |
| | in terms of components (such as |
| | “one-component,” “two-component”). |
| | A two-component cure system operates |
| | by mixing two components together. A |
| | one-component system does not require |
| | the combination of two components. |
| Alias Name | This property identifies a name |
| | commonly used in an industry to refer |
| | to a product instead of the product's |
| | trade/product name (e.g., Loctite |
| | 3103 ™ is commercially referred |
| | to as Loctite Blue ™). |
| Application Rate | This property refers to the rate at which |
| | a specific amount of the product may be |
| | applied (e.g., in terms of quantity of |
| | mass per time). This property is |
| | particularly pertinent to extruding, |
| | spraying or squeeze-tube applications. |
| Application Temperature Range | This property refers to an optimum |
| | temperature at which the product will |
| | properly cure. |
| Application Type | This property refers to a non-specific |
| | explanation of applications for which |
| | the product is designed (such as sealing, |
| | bonding, coating, etc.). |
| Approvals | This property refers to third party |
| | approvals and ratings given to a product |
| | by organizations such as UL, FDA, and |
| | ASTM. |
| Cure Temperature | This property refers to the temperature |
| | at which the properties of a material |
| | change as a result of chemical reactions. |
| | It frequently involves a physical change |
| | from liquid to the solid state (often |
| | referred to as “hardening” or |
| | “setting”). Fully cured materials |
| | exhibit maximum physical, thermal and |
| | chemical properties in use. |
| Cure Type | This property defines the chemical |
| | process which the material cures (such |
| | as room temperature cure, RTV cure, |
| | high temperature cure, etc.). |
| Dielectric Strength | This property refers to the maximum |
| | voltage required to produce a dielectric |
| | breakdown. |
| Dynamic Joint Movement | This property refers to the percent of |
| | movement a sealant can sustain. |
| Elongation % | This property refers to the amount in |
| | percent that a specimen can stretch |
| | before material break occurs. |
| Form | This property refers to pre-cure |
| | equilibrium state of a product, or how |
| | the material is supplied to the end-user |
| | (such as liquid, gel, paste, etc.) |
| Grade | This property identifies a material and |
| | is associated with a particular product |
| | name (such as Proglaze II ™, |
| | Spectrem 1 ™, Vulkem 202 ™, etc.). |
| | For example, in the last-cited sealant, |
| | the product name is “Vulkem,” and |
| | the product grade is “202.” |
| Manufacturer | This property indicates the organization |
| | that manufactures or supplies the |
| | material (such as GE Silicones, Tremco, |
| | Loctite, etc.). |
| Material | This property identifies the generic |
| | chemistry by which the particular |
| | product is manufactured (e.g., silicone, |
| | polyurethane, epoxy.) |
| Maximum/Minimum Joint | This property identifies the depth and |
| Dimension | width at which the sealant is at its |
| | maximum/minimum design capability |
| | relating to movement. |
| Peel Adhesion | This property identifies an adhesive's |
| | resistance to being stripped from a |
| | bonded joint with the stripping force |
| | applied at a predetermined angle and |
| | rate. |
| Performance Range | This property refers to temperatures at |
| | which the sealant/adhesive will exhibit |
| | its optimal properties. |
| Product Name | This property identifies the name given |
| | to a line of materials by a manufacturer |
| | (such as Proglaze ™, Spectrem ™, |
| | Vulkem ™). |
| PSI Stress @ 50% Extension | This property defines the percent by |
| | which the cured product can be pulled. |
| Sag/Slump | This property defines a post-cure |
| | decrease in the thickness of a polymer |
| | section. |
| Shelf Life | This property defines the period of time |
| | a product can be stored without |
| | degrading or curing. |
| Substrate 1 | This parameter defines the surface upon |
| | which the adhesive is applied and to |
| | which it is expected to adhere (such as |
| | stainless steel, plastic, ceramic, etc.) |
| Substrate 2 | This parameters defines another surface |
| | upon which the adhesive is applied and |
| | to which it is expected to adhere (such |
| | stainless steel, plastic, ceramic, etc.). |
| Tack Free Time | This property refers to the time it takes |
| | a material to cure to the point of losing |
| | its immediate stickiness. |
| Tensile Strength | This property defines the amount of |
| | force required to break the material per |
| | unit area. |
| Tooling Time | This property refers to the time it takes |
| | a material to form a surface layer or |
| | skin. |

In the specific case of FIG. 8, the user is being prompted to identify which ones of the following parameters are considered important to his or her query: application type; substrate 1; substrate 2; adhesive type; cure temperature; performance range; application rate; grade; tack free time; application temperature range; tooling time; max/min joint dimension; and tensile strength. In this exemplary scenario, the user considers “application type,” “substrate 1” and “substrate 2” as important parameters, as indicated by the user's selection of these parameters. The user initiates the search thus defined by activating search icon 816 (“search now”).

Information presented in screen 802 may dynamically change as the user fills in information requested by this screen. For instance, the order processing system 208 may present different selections of properties in field 814 depending on the selections that the users makes in input boxes 808, 810 and/or 812. In another embodiment, a user's selection of an entry in a pull-down menu may cause the list of entries displayed in other pull-down menus (e.g., that have yet to be selected) to change. This dynamic self-populating feature is advantageous because it focuses the user's attention on search options that may be important to his or her objectives, without requiring the user to tediously sequence through many irrelevant menu items. The order processing system 208 may implement this feature by storing an indication of the various menu listings that may be provided by the system, as well as the input parameters which trigger the respective menu listings. Thus, when the user specifies one or more input parameters, the order processing system responds by accessing and displaying appropriate tables to guide subsequent entry of information.

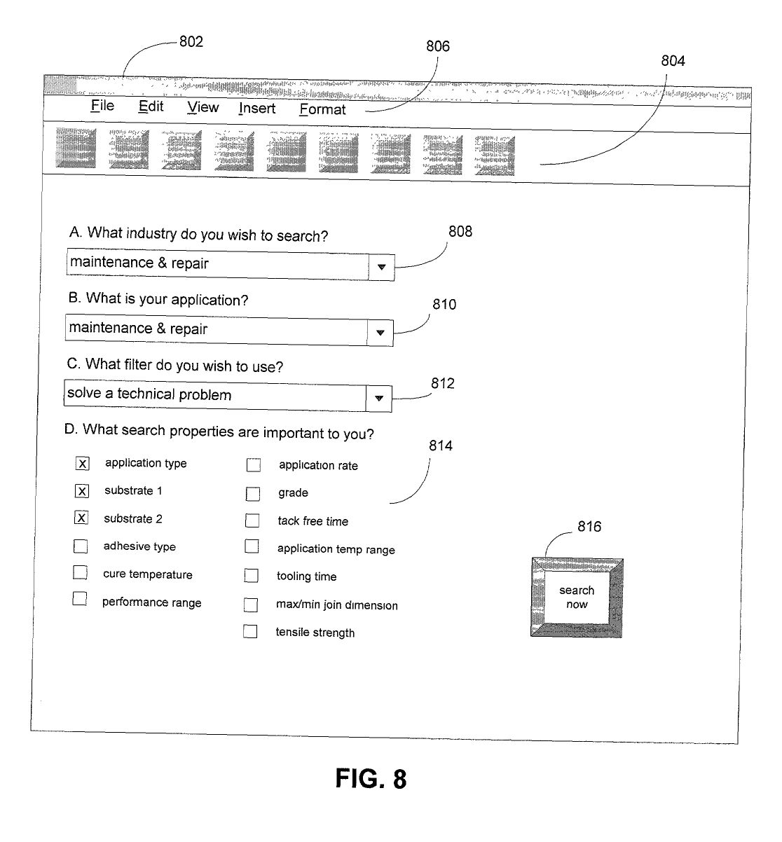

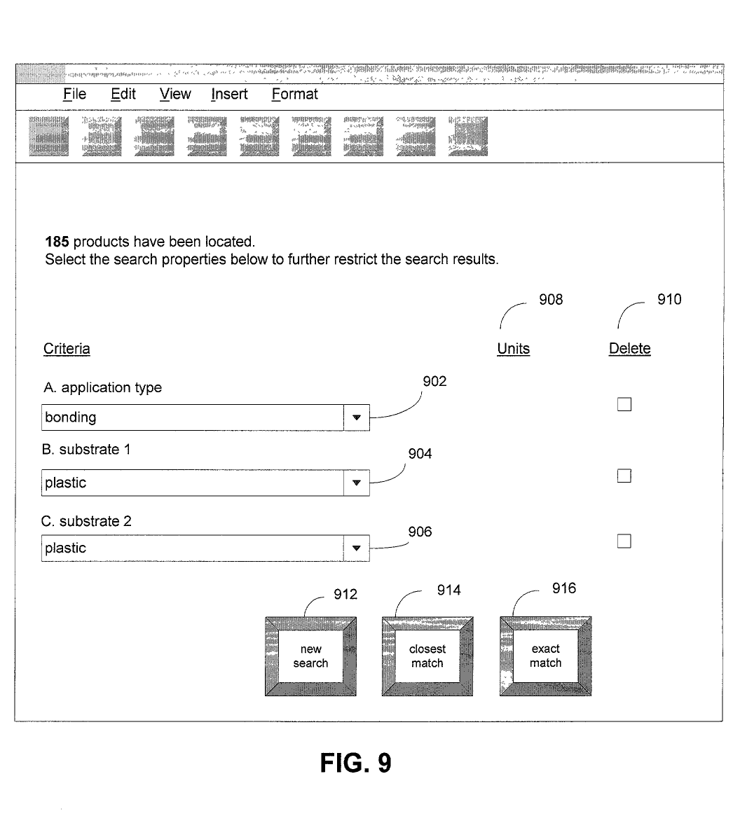

Returning momentarily to the process flow of FIG. 6, in step 612, the user is next requested to input values for the parameters that were identified as “important” (e.g., via field 814 of FIG. 8). FIG. 9 shows an exemplary input screen for entering these values. As indicated there, the processing system 208 identifies that 185 products have been located that are relevant to the query specified thus far (e.g., as specified in step 602 of FIG. 6). To further narrow the search, the screen shown in FIG. 9 prompts the user to select specific values for the properties identified as being “important” in field 814 of FIG. 8.

More specifically, input box 902 includes a pull-down menu that allows a user to select values for the first property indicated as being “important,” namely application type. Exemplary application-related categories include: bonding; glazing; weather-stripping; sealant; coating; repellent; waterproofing; primer; encapsulating/potting/molding/grouting, etc. Those skilled in the art will appreciate that the order processing system 208 may include additional categories that may be appropriate to other technical fields. In the example shown in FIG. 9, the user has selected the “bonding” category (e.g., by clicking on the appropriate entry in the pull-down menu).

Input box 904 includes a pull-down menu that allows a user to select values for the second property indicated as being “important,” namely substrate1 (i.e., a first substrate that the sealant is expected to adhere to.) Exemplary substrate-related categories include: plastic; glass; paper; wood; ceramic; composite; textile; various/other; rubber; masonry/stone; metal/alloys, etc. Those skilled in the art will appreciate that the order processing system 208 may include additional categories that may be appropriate to other technical fields. In the example shown in FIG. 9, the user has selected the “plastics” category (e.g., by clicking on the appropriate entry in the pull-down menu).

Input box 906 includes a pull-down menu that allows a user to select values for the third property indicated as being “important,” namely substrate 2 (i.e., a second substrate that the sealant is expected to adhere to). The exemplary substrate-related categories identified above with respect to the input box 904 apply here as well. In the example shown in FIG. 9, the user has again selected the “plastics” category (e.g., by clicking on the appropriate entry in the pull-down menu).

The screen shown in FIG. 9 also includes a “Units” field 908 for displaying any units that may be appropriate to the selected parameters. Further, the screen shown in FIG. 9 includes a “Delete” field 910. This field allows a user to remove one or more properties selected in field 814 of FIG. 8. Namely, to delete a property, the user points to and clicks on a box shown to the left of a corresponding search criteria property (e.g., using a mouse-type point and click device). This feature allows a user to broaden a search by removing search constraints. A user may find this tactic appropriate when he or she initially defines a search too narrowly, resulting in the retrieval of an inadequate number of search hits (or no hits at all). Instead of modifying the search, the user may start from “scratch” by activating the “new search” icon 912. Activating the “new search” icon 912 will allow the user to repeat the query-specification process defined in steps 604 to 610 of FIG. 6.

When the user is satisfied with his or her search query as defined through the screens shown in FIGS. 8 and 9, the user activates the search by pressing either the closest match icon 914 or the exact match icon 916. The exact match icon identifies only products that exactly match the input search parameters. On the other hand, the closest match search icon 916 identifies products that most closely match the search parameters, but may not exactly match the search parameters. For instance, in the latter case, the order processing system 208 may initially attempt to identify the products that satisfy all of the selected search parameters. If an insufficient number of entries are found (e.g., if no entries are found), the order processing system may repeat the search by omitting one or more parameters. Other techniques for assessing the similarity between products may be used. For instance, the search engine may use various search rules which reproduce a human expert's judgment in assessing the similarity between products.

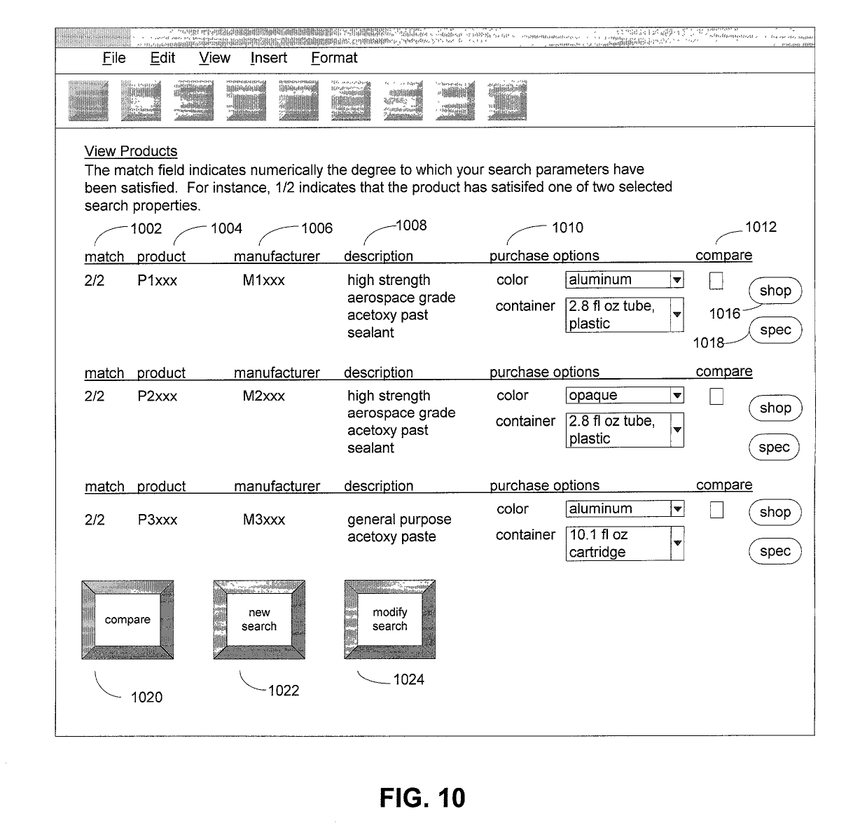

Returning momentarily to FIG. 6, the process next advances to step 614. In this step, the product ordering system 208 displays information regarding products that match the search query. FIG. 10 shows an exemplary screen that presents matching products. As indicated there, the order processing system 208 identifies the matching products in a table-type format. A first field 1002 indicates the extent to which a product matches the input query. For instance, the information “2/2” indicates that the search query specifies two parameters and the matching product satisfies both parameters. A second field 1004 identifies the product (e.g., by identifying its commercial name, or other identification). A third field 1006 identifies the manufacturer of the product. A fourth field 1008 identifies a short description of the product. A fifth field 1010 identifies purchase options relating to the sale of the product. In the illustrated case, the order processing system 208 provides, for each product entry, two respective input boxes for inputting the color of the product and the container used to dispense the product. These input bocks include pull-down menus which are populated with appropriate input responses.

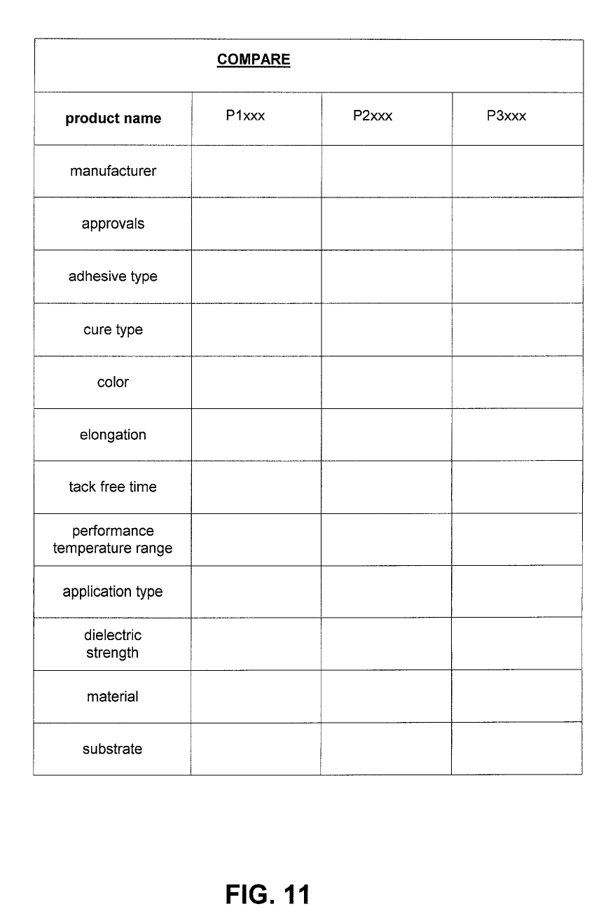

Field 1012 (“compare”), in association with icon 1020, allow a user to compare products. To perform this function, the user clicks on the boxes in the compare field 1012 associated with two products that are to be compared. The user then activates the compare icon 1020. This prompts the order processing system 208 to generate a table that compares the selected products by showing their properties in side-by-side relationship to each other. FIG. 11 shows one such exemplary table. As indicated there, each column of the table corresponds to different selected products. Each row of the table corresponds to a different property of the products (such as the properties discussed in Table 1 above). This table allows a user to identify the relative merits and deficiencies of the products, and therefore make a more intelligent choice regarding the purchase of the products.

Returning to FIG. 10, the user may also retrieve detailed information regarding a specific product by activating a “spec” icon associated with a product (such as spec icon 1018 associated with the first-listed product). Alternatively, the user may initiate a request to purchase the selected items by activating a “shop” icon associated with a product (such as shop icon 1016 associated with the first-listed product).

Still alternatively, if the user is dissatisfied with the nature or number of products retrieved, the user may activate a “new search” icon 1022 to input a new search query from “scratch.” Alternatively, the user may merely modify a previous search by activating the “modify search” icon 1024.

FIG. 6 summarizes the above-discussed courses of actions in steps 616 to 626. Namely, the order processing system 208 waits to receive an input from the user that identifies one of the above-described functions. In step 616, the order processing system 208 receives the user's input. This prompts the order processing system 208 to provide the requested service (in step 618). As discussed above, the screen page shown in FIG. 10 allows a user to compare products (in routine 620), modify the search or request a new search (in routine 622), review specifications regarding one or more products (in routine 624), or purchase one or more products (in shop routine 626).

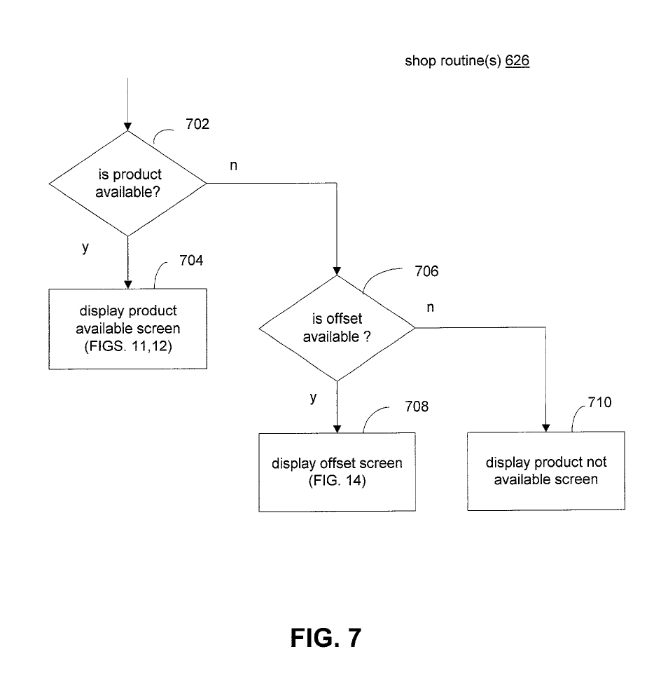

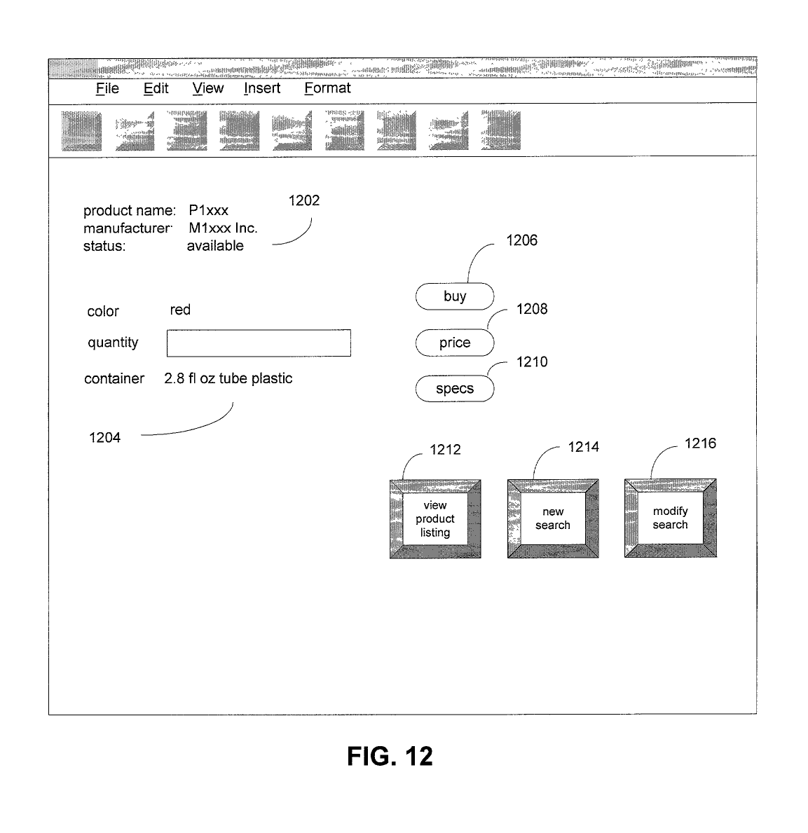

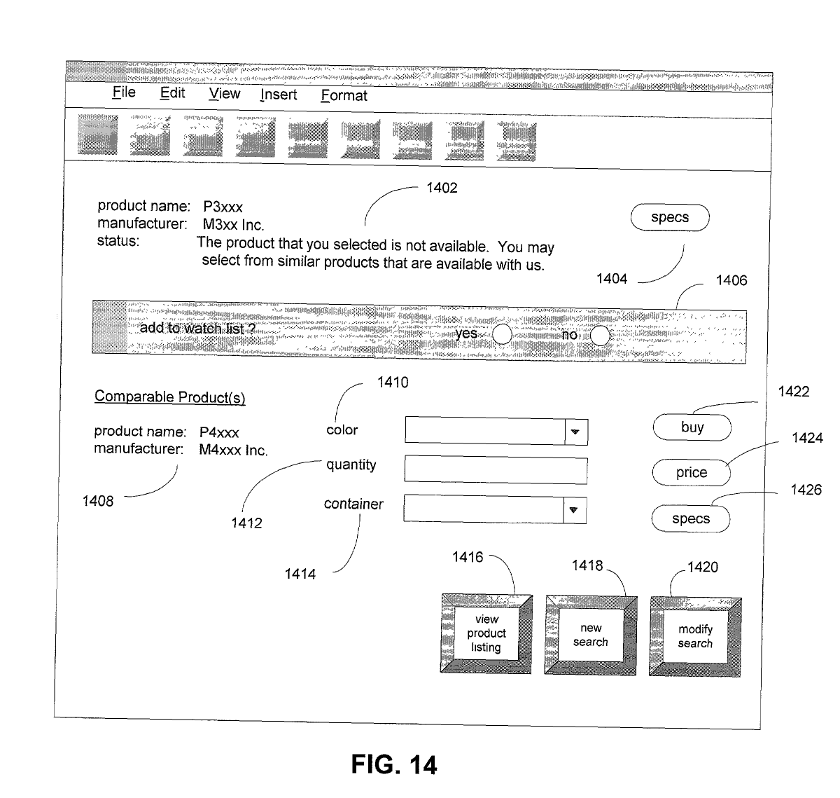

FIG. 7 identifies selected steps in the order processing routine 626. In this procedure, the order processing system 208 first determines whether the selected product is available (in step 702). If so, the order processing system 208 displays one or more appropriate “product available screens” (e.g., with reference to FIGS. 11 and 12). If the selected product is not available, the order processing system 208 determines whether there is an available product that is related to the selected product. In the terminology of FIG. 7, the system 208 determines whether an “offset” is available (in step 706). If so, the order processing system 208 displays one or more “offset screens” (e.g., with reference to FIG. 14). If no offset is available, the order processing system 208 displays one or more “product not available screens” (in step 710) (which include a message indicating that the selected product is not available).

The shopping routine 626 may be better understood by momentarily referring back to FIG. 1. As shown there, a user's search may initially identify a product *P_{match} that lies within the universe of searchable products 104, yet is unavailable, meaning that it lies outside the group of available products 106. If possible, the order processing system 208 rectifies this shortcoming by generating an offset that identifies one or more products within the group of available products 106, such as *P_{available}. The order processing system 208 may use various algorithms to performing this offsetting function. For instance, the database 210 may contain explicit information which links unavailable products to related available products (e.g., using various types of links, such as pointers). Alternatively, the order processing system may identify the offset product by varying the input search query (e.g., by omitting a specified search parameter or otherwise “loosening” the search criteria). Still other techniques can be used to extend a search to include the identification of one or more available products (such as various types of clustering analysis, weighting analysis, etc.).

FIGS. 12-14 provide additional information regarding the processing shown in FIG. 7. For instance, FIG. 12 shows a screen that is displayed when the user selects an available product. This screen includes a first field 1202 that identifies the product name, the product manufacturer, and the status of the product (i.e., that it is available for purchase). In field 1204, the order processing system allows a user to specify the quantity of the product that he or she wishes to purchase (e.g., by specifying the number of units, or other measure of quantity, that the user wishes to purchase). In addition, field 1204 confirms the user's prior selection of product color (e.g., red) and product container (e.g., 2.8 fl. oz tube plastic). The user entered this color/container information via the purchase option field in the context of the screen shown in FIG. 10.

Icon 1206 allows a user to purchase the identified product. Icon 1208 allows a user to review pricing information pertaining to the identified product. Icon 1210 allows a user to review specification information pertaining to the identified product. Icon 1212 allows a user to return to the product listing screen shown in FIG. 10. Icon 1214 allows a user to initiate a new search “from scratch.” Finally, icon 1216 allows a user to modify a search, e.g., by returning to one of the query specification screens (such as the screen shown in FIG. 8) to alter the selection of search parameters.

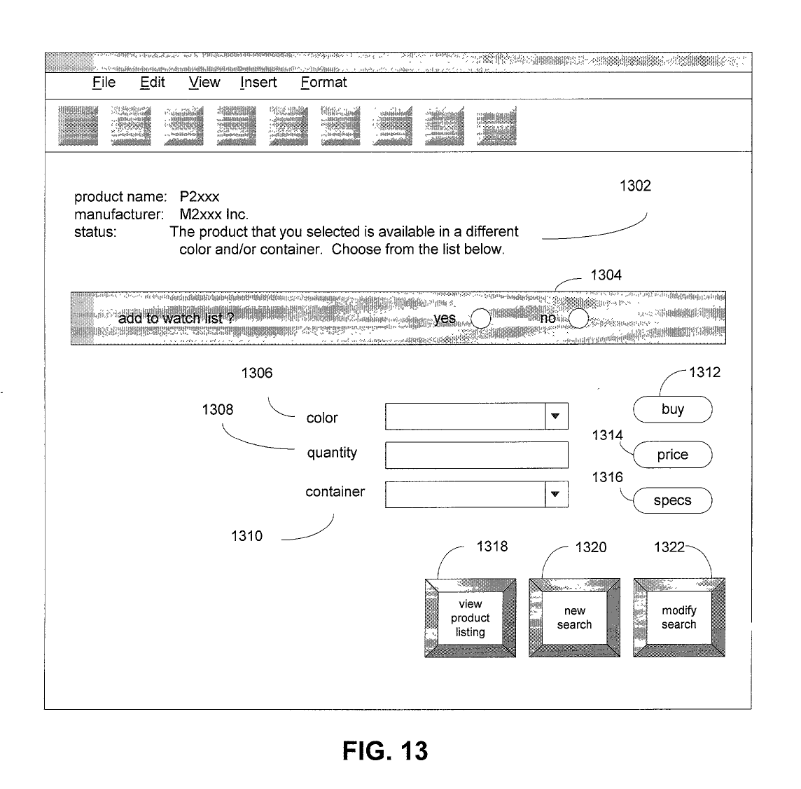

FIG. 13 presents another screen that notifies the user that the selected product is available. However, in the case of FIG. 13, the user has specified purchase options that cannot be satisfied. The order processing system 208 notifies the user of this fact in field 1302 (e.g., by stating that “The product that you selected is available in a different color and/or container”). The screen shown in FIG. 13 then prompts the user to input a different combination of color, quantity and container (in input boxes 1306, 1308, and 1310, respectively). In one embodiment, each of the illustrated input boxes contains a pull-down menu listing a series of possible input entries. Other features of FIG. 13 resemble corresponding features of FIG. 12, including icons 1312 to 1322.

As an alternative option, the screen shown in FIG. 13 allows a user to place a selected unavailable product on a wait list via a “watch list” input field 1304. Then, if the selected item becomes available in the future, the order processing system 208 notifies the user of such availability (e.g., via e-mail, physical mail, facsimile, etc.). Alternatively, the order processing system 208 may be configured to automatically order the selected product when it becomes available.

FIG. 14 corresponds to the case where a selected product is completely unavailable (that is, the selected product is not available in any color/container combination). This screen notifies the user of the product's status in field 1402 (e.g., by stating “The product that you selected is not available”). However, instead of completely abandoning the user with no options, the order processing system 208 offers the user one or more comparable products (if such products are available). Namely, field 1408 identifies the name and manufacturer of a product that is related to the selected unavailable product. Fields 1410, 1412 and 1414 allow a user to specify the color, quantity, and container of the related product, respectively (e.g., using pull-down menus in the manner described above). Icon 1422 allows a user to purchase the related product. Icon 1424 allows a user to retrieve price information regarding the related product. Icon 1426 allows a user to retrieve specification information regarding the related product. On the other hand, icon 1404 allows a user to retrieve specification information regarding the unavailable item identified in field 1402. Finally, icons 1416 to 1420 activate the same functions discussed in the context of FIGS. 12 and 13.

FIG. 14 also provides a wait list option in field 1406. Namely, if the user requests this option, the order processing system places the selected unavailable product on a waiting list. Then, if the selected item becomes available, the order processing system 208 notifies the user of such. Alternatively, the order processing system 208 may be configured to order the selected product automatically when it becomes available.

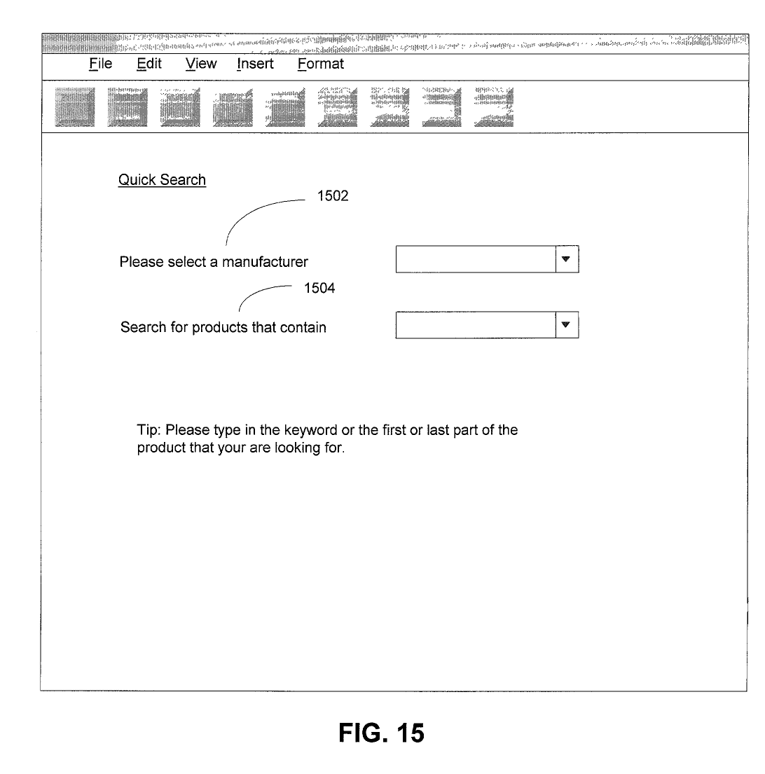

The remaining two figures identify alternative ways of purchasing products. More specifically, FIG. 15 shows a quick search screen that implements the quick search routine 512 of FIG. 5. This screen allows a user to retrieve products by specifying only the manufacturer and a key term associated with the product via fields 1502 and 1504., respectively. The order processing system 208 may respond to a user's selection in these fields by displaying a list of matching products using, for example, the display format shown in FIG. 10. The user may then proceed to investigate and purchase the identified products in the manner discussed above.

Another quick search option allows a user to enter a partial product name or grade, and then activate a search icon to retrieve any products in the database that match such input information. This function may also allow a user to specify whether the product starts with or contains the specified input information.

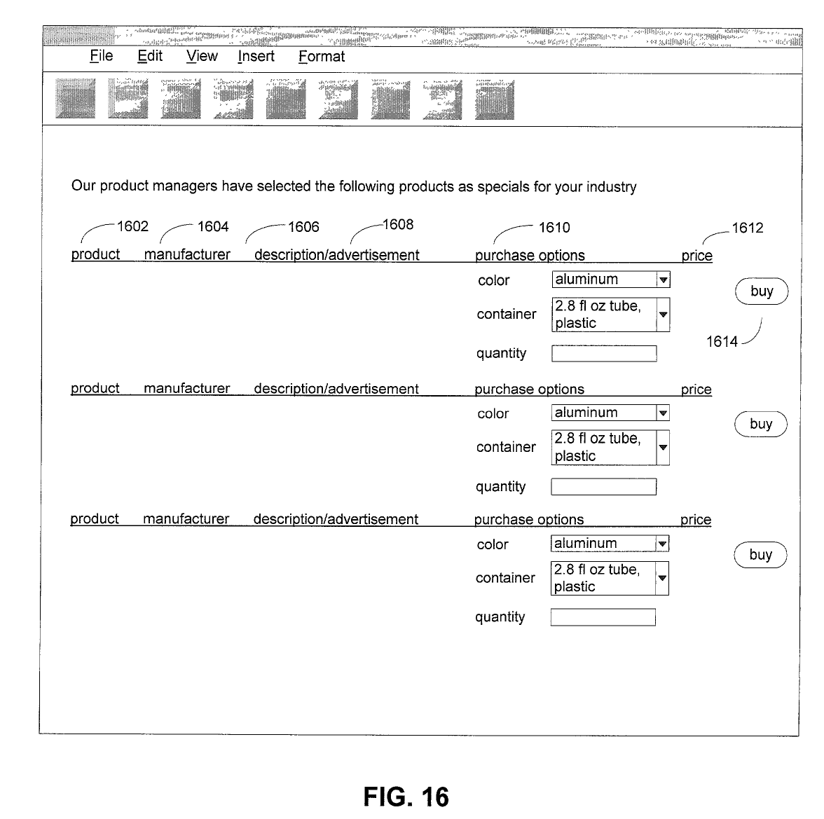

FIG. 16 shows a list of products that may be automatically generated for the user based on a user's affiliation with a particular industry and/or based on the user's past interest in products (e.g., as reflected by the user's past search activity and purchase activity). This list may be retrieved by activating an appropriate icon in the introductory page. The list itself includes a product field 1602 that identifies the product (e.g., by providing its commercial name), a manufacturer field 1604 that identifies the manufacturer of the product, a description/advertisement field 1608 that contains a short description and/or sales pitch relating to the product, a purchase options field 1610 that allows the user to identify the color, container and quantity of a selected product, a price field 1612 that identifies the price of the product, and a buy icon (for each product) that allows a user to purchase the product.

Additional screens and shopping functionality may be added to the order processing system 208, as will be appreciated by those skilled in the art.

Generally, various modifications to the embodiments described above can be made without departing from the spirit and scope of the invention, as is intended to be encompassed by the following claims and their legal equivalents.

What is claimed is:

1. An order processing station for retrieving information pertaining to a product, comprising:
a processor;
a memory;
a communication interface for interacting with at least one input station;
processing functionality, in conjunction with the processor and the memory, for performing the functions of:
(i) receiving a search query from a user, via the at least one input station, pertaining to a desired product;
(ii) investigating a database to determine whether any products include features which satisfy the query;
(iii) informing the user that the desired product is not available, if the database indicates that the product is not available;
(iv) recommending an alternative product as a proposed substitute for the desired product; and
(v) receiving a request from the user to order the alternative product and/or to place a request for the desired product on a waiting list to purchase when it becomes available.

2. A system for retrieving information pertaining to a product, comprising:
a user input station;
a database containing information pertaining to products, the database including:
first information identifying a set of searchable products;
second information identifying a set of available products;
an order processing station for interacting with the user input station, including:
logic for prompting a user to input a search query pertaining to a desired product, and for receiving the search query;
logic for investigating the first information in the database to determine whether any products include features which satisfy the search query, and for generating search results;
logic for notifying the user of the search results;
logic for receiving a request from the user to select at least one product identified in the search results;
logic for informing the user of the availability of the selected at least one product by making reference to the second information in the database, including:
(i) informing the user that the selected at least one product is available, if the database indicates that the selected at least one product is available;
(ii) informing the user that the selected at least one product is not available, if the database indicates that the selected at least one product is not available;
(iii) informing the user that at least one alternative product is available that is related to the at least one selected product, if the database indicates that the at least one selected product is not available and the at least one alternative product is available; and
logic for processing a user's order for at least one product.

3. The system of claim 2, wherein the database contains information pertaining to chemical products.

4. The system of claim 2, wherein the database contains information pertaining to sealant-related and/or adhesive-related products.

5. The system of claim 2, wherein the logic for prompting includes logic for querying the user to input an industry designation related to a topic of inquiry.

6. The system of claim 2, wherein the logic for prompting includes logic for querying the user to input an application-related designation related to a topic of inquiry.

7. The system of claim 2, wherein the logic for prompting includes logic for querying the user to input a filter-related designation to be applied to the search query.

8. The system of claim 2, wherein the logic for prompting includes logic for querying the user to specify an identified set of search properties related to the desired product.

9. The system of claim 8, wherein the identified set of search properties is determined based on the user's specification of at least one of: an industry designation related to a topic of inquiry; an application-related designation related to the topic of inquiry; and a filter-related designation to be applied to the search query.

10. The system of claim 8, wherein the logic for prompting includes logic for prompting the user to input values for the identified set of search properties.

11. The system of claim 2, wherein the logic for notifying the user of the search results includes logic for identifying a list of products matching the search query.

12. The system of claim 11, further including logic for comparing at least two of the products identified in the list on the basis of at least one parameter.

13. The system of claim 2, wherein the logic for informing the user of the availability of the selected at least one product includes logic for placing a request for the selected at least one product on a wait list, at the option of the user, if the database indicates that the selected at least one product is not an available product.

14. The system of claim 2, wherein the at least one alternative product is produced by a manufacturer selected from a preferred group of manufacturers.

15. A method for retrieving information pertaining to a product, comprising:
receiving a search query from a user pertaining to a desired product;
investigating a database to determine whether any products include features which satisfy the query, and for generating search results;
informing the user that the desired product is not available, if the database indicates that the product is not available;
recommending an alternative product as a proposed substitute for the desired product; and
receiving a request from the user to order the alternative product and/or to place a request for the desired product on a waiting list.

16. A method for retrieving information pertaining to a product, comprising:
prompting a user to input a search query pertaining to a desired product;
investigating a database to determine whether any products include features which satisfy the query, and for generating search results;
notifying the user of the search results;
logic for receiving a request from the user to select at least one product identified in the search results;
logic for informing the user of the availability of the selected at least one product by making reference to the database, including:
(i) informing the user that the selected at least one product is available, if the database indicates that the selected at least one product is available;
(ii) informing the user that the selected at least one product is not available, if the database indicates that the selected at least one product is not available;
(iii) informing the user that at least one alternative product is available that is related to the at least one selected product, if the database indicates that the at least one selected product is not available and the at least one alternative product is available; and
processing a user's order for at least one product.

17. The method system of claim 16, wherein the database contains information pertaining to chemical products.

18. The method of claim 16, wherein the database contains information pertaining to sealant-related and/or sealant-related products.

19. The method of claim 16, wherein the step of prompting includes querying the user to input an industry designation related to a topic of inquiry.

20. The method of claim 16, wherein the step of prompting includes querying the user to input an application-related designation related to a topic of inquiry.

21. The method of claim 16, wherein the step of prompting includes querying the user to input a filter-related designation to be applied to the search query.

22. The method of claim 16, wherein the step of prompting includes querying the user to specify an identified set of search properties related to the desired product.

23. The method of claim 22, wherein the identified set of search properties is determined based on the user's specification of at least one of: an industry designation related to a topic of inquiry; an application-related designation related to the topic of inquiry; and a filter-related designation to be applied to the search query.

24. The method of claim 22, wherein the step of prompting includes prompting the user to input values for the identified set of search properties.

25. The method of claim 16, wherein the step of notifying the user of the search results includes logic for identifying a list of products matching the search query.

26. The method of claim 25, further including a step of comparing at least two of the products identified in the list on the basis of at least one parameter.

27. The method of claim 16, wherein the step of informing the user of the availability of the selected at least one product includes a step of placing a request for the selected at least one product on a wait list, at the option of the user, if the database indicates that the selected at least one product is not an available product.

28. The method of claim 16, wherein the at least one alternative product is produced by a manufacturer selected from a preferred group of manufacturers.

29. A processor readable medium for providing instructions to at least one processor for directing the at least one processor to perform the method recited in claim 16.

30. A computer signal embodied in a carrier wave readable by a computing system and encoding a computer program of instructions for executing a computer process performing the method recited in claim 16.
